(19) United States
(12) Patent Application Publication
(10) Pub. No.: US 2005/0227529 A1
(43) Pub. Date: Oct. 13, 2005

(54) Multi-conductor parallel splice connection

(75) Inventors: Matthew Mrakovich, Streetsborough, OH (US); Jeffrey Nall, Brecksville, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: GELcore LLC

(21) Appl. No.: 10/820,838

(22) Filed: Apr. 8, 2004

(51) Int. Cl. H01R 4/24

(52) U.S. Cl. 439/402

(57) ABSTRACT

A splice connector includes a clam shell housing having a first portion attached to a second portion via a sliding hinge. The housing defines cable seats to receive an associated cable to be spliced to another associated cable. A terminal is received in the housing and includes a first prong aligned with the first cable seat and a second prong aligned with the second cable seat. The terminal electrically connects a wire of the first associated cable to a wire of the second associated cable.

### BACKGROUND

Typically splice connection methods for parallel cables require a custom crimp tool to close the splice connector, wire nuts, or a butt splice connection method. A known splice connector used to connect LED light strings includes a plastic middle section having two double-ended insulation piercing terminals mounted in the middle section. The piercing elements protrude from each side of the middle section. Two plastic outer sections snap onto opposite sides of the middle section trapping a cable between the middle section and each outer section. The terminals pierce the insulation surrounding the wires of the cable to contact the wires. Such a splice connector can require a special tool to connect the sections and splice the cable.

It is desirable to provide a multi-conductor parallel splice connector that eliminates the need for a custom crimp tool and provides a more robust and reliable connection.

### SUMMARY OF THE INVENTION

A splice connector includes a clam-shell housing having a first portion attached to a second portion via a sliding hinge. The housing defines a first cable seat and a second cable seat, each seat receives an associated cable to be spliced to another associated cable in the other seat. A terminal is received in the housing and includes a first prong aligned with the first cable seat and a second prong aligned with the second cable seat. The terminal electrically connects a wire of the first associated cable to a wire of the second associated cable.

A splice connector includes a first housing, a second housing attached to the first housing, and first and second terminals received in the first housing. The first housing defines first and second cable receptacles spaced from one another in a first direction. The first and second terminals are spaced from one another in a second direction generally parallel to the first direction. Each terminal includes a first prong aligned with the first cable receptacle and a second prong aligned with the second cable receptacle.

A method for splicing two electrical cables, where each cable includes at least two conductive wires and insulation material around each wire, with a splice connector having a clam-shell housing includes the following steps: positioning first and second cables in respective first and second seats in a first housing portion of the clam-shell housing, rotating a second housing portion of the clam-shell housing in relation to the first housing portion, linearly moving at least one of the first housing portion and the second housing portions in relation to the other housing portion, and piercing the insulation material of the first and second cable with IDC terminals received in one of the housings to contact a first of the at least two conductor wires in each cable.

### BRIEF DESCRIPTION OF FIGURES

FIG. 1 is a perspective view of a splice connector in a closed position splicing two cables together.

FIGS. 2 and 3 a perspective views of the splice connector of FIG. 1 in an open position.

FIG. 4 is a side view of the splice connector in a closed position with inner portions of the connector shown in phantom.

FIGS. 5, 6 and 7 are side views of the splice connector showing the steps of splicing two cables together.

FIG. 8 is a schematic view of a channel letter having a light engine and the splice connector of FIG. 1 mounted therein.

### DETAILED DESCRIPTION

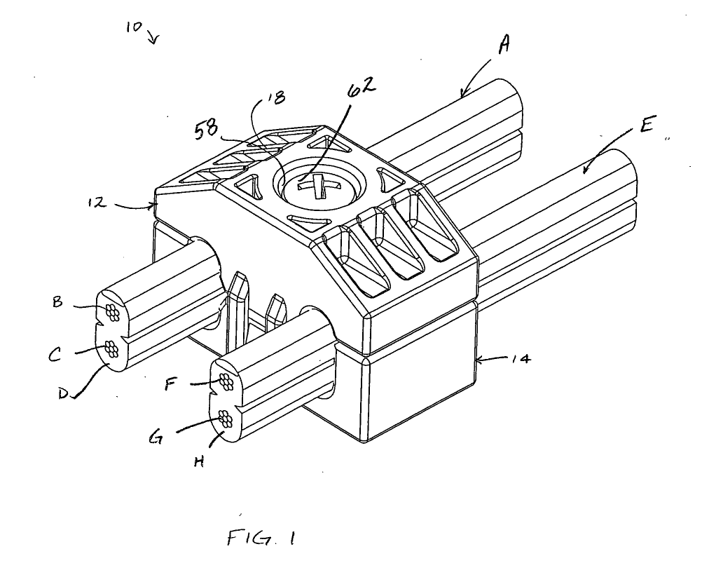

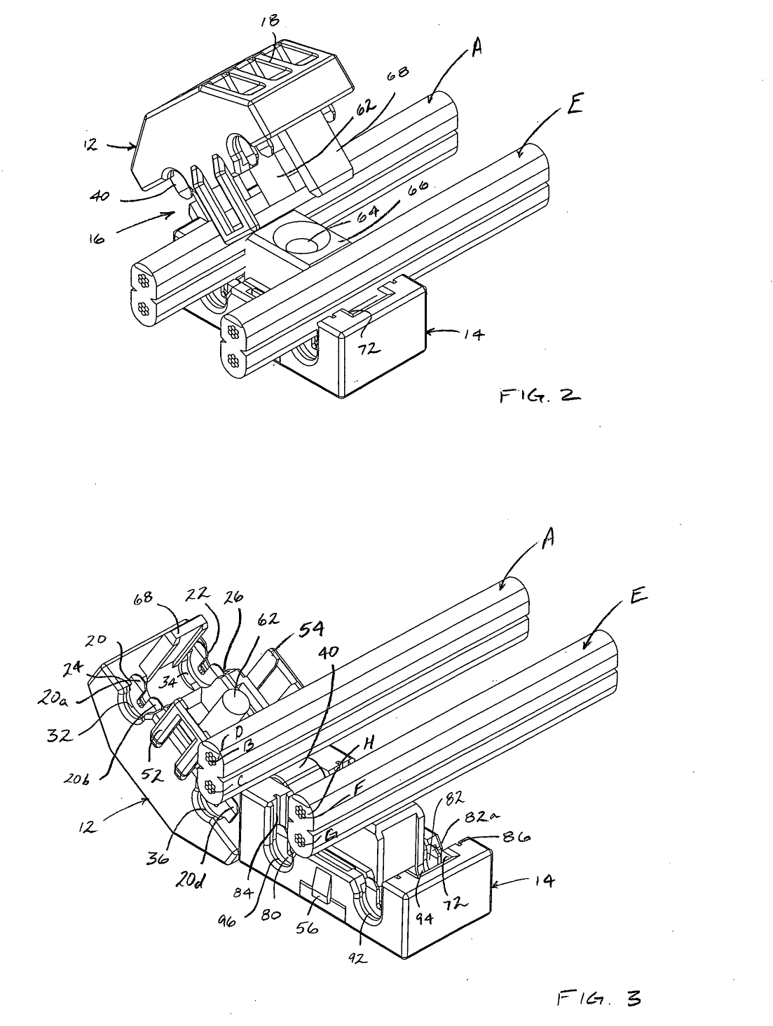

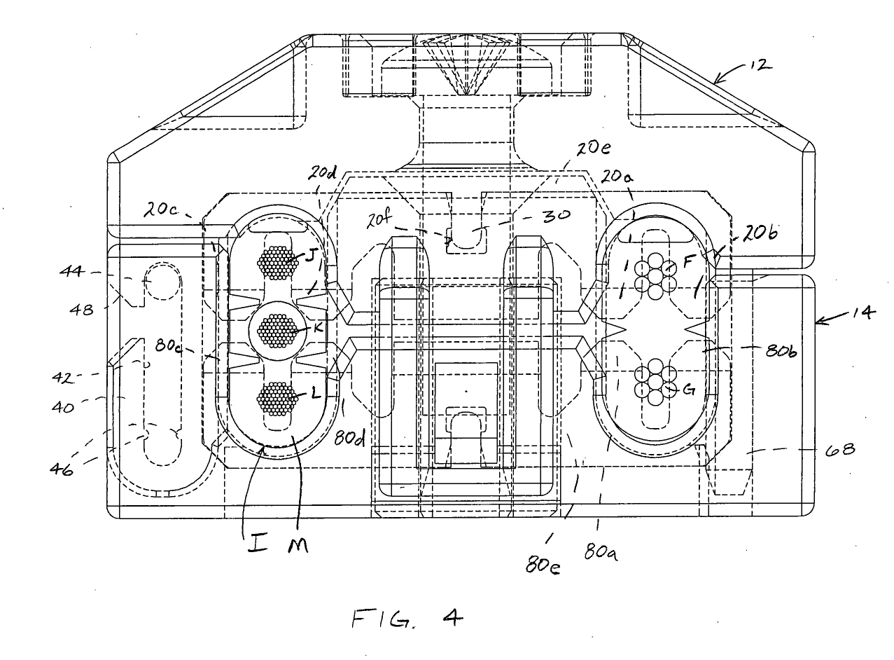

With reference to FIG. 1, a splice connector 10 includes a detachable clam-shell housing having an upper housing portion 12 selectively attached to a lower housing portion 14 by a sliding hinge 16 (FIG. 2). The splice connector 10 electrically connects two multi-conductor parallel cables. By way of example as shown in FIG. 1, the splice connector 10 electrically connects a first cable A having conductor wires B and C surrounded by insulation D to a second cable E having conductor wires F and G surrounded by insulation H. Cables having a greater number of conductor wires can also be connected, for example FIG. 4 depicts a cable I having three conductor wires J, K, and L surrounded by insulation M.

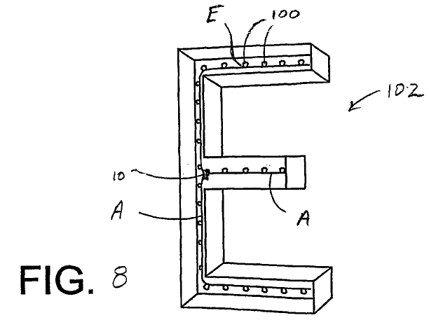

The splice connector 10 can be used to splice together two cables having a plurality of LEDs 100 attached to the cable (FIG. 8). Such a light engine is more particularly described in U.S. Pat. No. 6,660,935 and International Application No. PCT/US02/16749, which are both incorporated by reference. The splice connector 10 can be used to splice together two cables A, E that are housed in a channel letter housing 102, or other environments including under cabinet lighting, architectural lighting as well as general illumination, which is also described in the publications that have been incorporated by reference.

For the sake of clarity when describing the figures only, and not to be limited to the orientations described, the connector 10 will be described as the sliding hinge 16 being on the proximal side and the opposite side will be referred to as the distal side. The front of the connector will refer to the side that is forward in the figures with the back or rear of the connector is opposite to the front. The terms “upper” and “lower” will also be used to more easily describe the figures; however, these terms are not to be taken as limiting.

The clam-shell housing is preferably made from a robust non-conductive material, such as plastic. The upper housing 12 includes a chamfered top and reinforcing members 18 to facilitate the use of a hand tool, such as pliers, to clamp down on the housings 12 and 14 to close the connector 10.

Referring to FIG. 3, upper front and rear insulation displacement connection (IDC) terminals 20 and 22 (collectively “the upper terminals”) are received in slots 24 and 26, respectively, that are spaced from one another and formed in the upper housing 12. The IDC terminals 20 and 22 are spaced along longitudinal axes of the cables A and E. Spacing along the longitudinal axes of the cables A and E provides a redundant connection between the cables, where if the cables are not electrically connected by the front terminal 20 they can be connected by the rear terminal 22.

In the embodiment depicted in the figures, the upper terminals 20 and 22 are substantially similar or identical, and for the sake of brevity only the front terminal 20 will be described in detail. With reference to FIG. 3, the front terminal 20 is a generally flat piece of metal having a distal set of prongs 20a, 20b that pierce the insulation H of cable E to contact upper wire F. The first terminal also includes a proximal set of prongs 20c, 20d (20c visible in FIG. 4) that pierce the insulation D of cable A to contact the upper wire B. As seen in FIG. 4, the distal prongs 20a and 20b are spaced from another so that wire F is received between the prongs. The prongs 20c and 20d are similarly spaced to the first set of prongs 20a, 20b. The terminal has been described as having a pair of prongs on each side; however, the terminal can include only one prong or a plurality of prongs on each side that displaces the insulation to contact the wire.

With continued reference to FIG. 4, a bridge 20e interconnects the distal set of prongs 20a, 20b to the proximal set of prongs 20c, 20d. The bridge 20e includes a notch 20f that receives and frictionally engages a projection 30 formed in the slot 24 that receives the terminal 20. The engagement between the notch 20f and the projection 30 retains the terminal 20 in the slot 24. The bridge 20e is integral with the prongs; however, in an alternative embodiment the bridge can include an electrically conductive element that electrically connects the prongs, for example a conductive wire or the like.

With reference to FIG. 3, the front distal prong set 20a, 20b aligns with a front distal cable seat or receptacle 32 formed in the upper housing 12. Likewise, the rear distal prong set 22a, 22b aligns with a rear distal cable seat or receptacle 34. The seats 32 and 34 are aligned with one another to receive cable A. The first housing 12 also includes a front proximal cable seat or receptacle 36 aligned with the proximal prong set 20c, 20d for the first terminal 20 and a rear proximal cable seat or receptacle (not visible) aligned with the proximal prong set (not visible) for the rear terminal. The curved receptacles are a complementary shape to the cables A, E and I and are formed on each side (front and rear) of the respective terminal 20 and 22 (see rear distal seat 34). The seats are described as curved to accommodate the cables; however, the seats can take other configurations, for example to accommodate cables of other shapes.

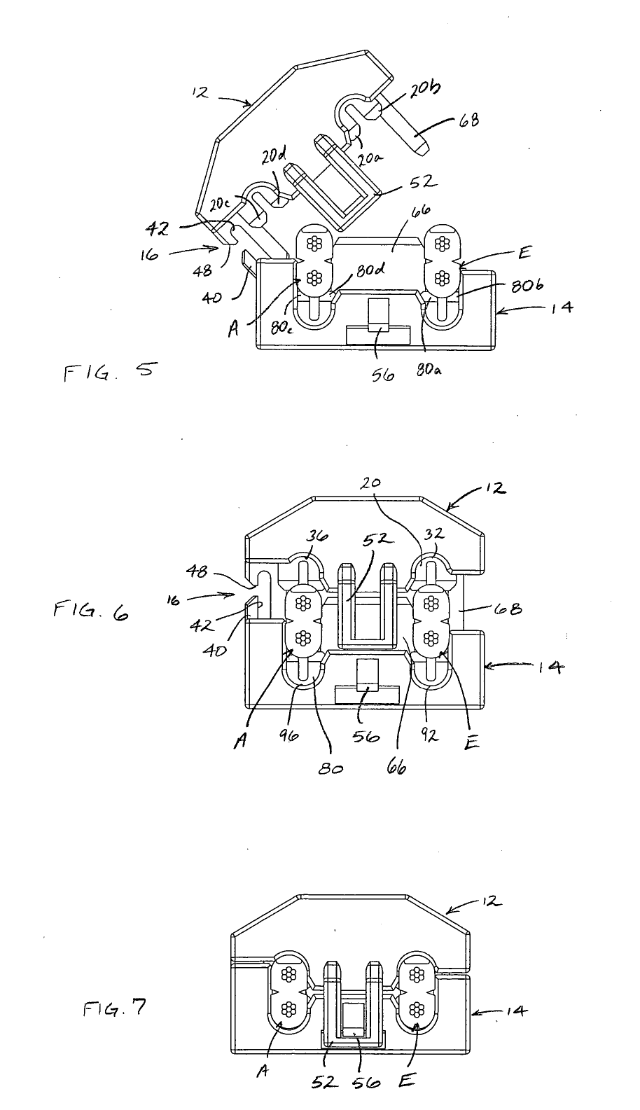

Referring to FIG. 5, the upper housing 12 includes a discontinuous hoop-shaped appendage 40 that forms a part of the sliding hinge 16. The appendage 40 is located about midway between the front and the back of the proximal side, as more easily seen in FIG. 3. The hoop-shaped appendage 40 includes an elongated slot 42. The elongated slot 42 has a height that is about or equal to the height of the cable (measured in a plane that intersects the conductors) received by the splice connector 10 and a width slightly larger than a pin 44 (FIG. 4), which is connected or integral to the second housing 14 and received in the elongated slot. A pair of catches 46, which in this embodiment are small bumps, are formed on opposite inner sides near the bottom of the elongated slot 42. The catches 46 are spaced from the bottom of the slot 42 enough that the pin 44 can temporarily remain between the bumps and the bottom of the slot to allow for easier rotation of the second housing 14 in relation to the first housing 12, which will be described in more detail below.

As mentioned above, the appendage 40 is discontinuous in that an opening 48 is formed in the appendage leading to the slot 42. The opening 48 in the appendage 40 is wider at the outside and tapers towards the slot 42. At its narrow side, the opening 48 is approximately equal to the diameter of the pin 44 so that the pin can be selectively inserted into and removed from the elongated slot 42 allowing the upper housing 12 to selectively connect and disconnect from the lower housing 14, which also facilitates manufacturing of the connector 10 since the housings 12 and 14 can be manufactured separately and fastened together.

The upper housing 12 also includes front and rear resilient clips 52 and 54, respectively, formed on opposite front and rear sides of the connector 10; the front and rear sides being perpendicular to the side having sliding hinge 16, i.e. the proximal side. The clips 52 and 54 cooperate with catches 56 (only one visible in FIG. 3) formed on the front and rear sides of the lower housing 14 to connect the upper housing 12 to the lower housing 14 when the connector 10 is closed. The clips 52 and 54 are positioned between the proximal and distal cable seats so that the clips are positioned between the cables A and E when the splice connector 10 is closed (FIG. 7). Alternative selective fasteners can be provided to close the connector 10 including, snaps, latches and the like. Alternatively, the clip can extend from the lower housing and the catch can be located on the upper housing.

With reference back to FIG. 1, the upper housing 12 includes an opening 58 that receives a fastener 62. The opening 58 is positioned between and aligned with the clips 52 and 54 so that the opening is positioned in the middle of the upper housing 12. The fastener 62 is received in an opening 64 formed in a boss 66 that extends upward from the center of the lower housing 14. The fastener 62 can include a screw that is threaded into the opening 64 in the boss 66 to tighten down the upper housing 12 with respect to the lower housing 14, or vice versa, to close the connector 10.

An alignment arm 68 extends from the upper housing 12 aligned with the opening 58 opposite the hinge 16. The alignment arm 68 is positioned adjacent the distal side and between the distal seats 32 and 34. The alignment arm 68 is received by a notch 72 formed in the distal side in the lower housing 14 when the splice connector 10 is closed.

Front and rear IDC terminals 80 and 82, respectively, (collectively “the lower terminals”) which are identical or similar to the upper terminals 20 and 22 described above, are received in front and rear narrow slots 84 and 86, respectively, of the lower housing 14. The front lower terminal 80 includes a distal set of prongs 80a, 80b and a proximal set of prongs 80c, 80d similar to the prongs described above. Likewise, the rear lower terminal 82 also includes a distal set of prongs 82a (only visible) and a proximal set of prongs (not visible) similar to the prongs described above. The lower terminals 80 and 82 also each include a bridge (80e visible in phantom in FIG. 4) similar to the bridge 20e described above to connect the distal prongs to the proximal prongs.

The lower housing 14 also includes lower curved cable seats or receptacles similar to those defined in the upper housing 12. The lower housing 14 includes a front distal seat 92 and a rear distal seat 94 that receive the cable E and a front proximal seat 96 and a rear proximal seat (not visible) that receive the cable A. The lowerfront distal seat 92 aligns with the front lower terminal 80 distal prongs 80a, 80b and the same pattern is followed throughout the lower housing 14 that was followed in the upper housing 12.

With reference to FIG. 6, the lower seats align with the upper seats prior to the closing of the splice connector. The lower front distal sent 92 aligns with the upperfront distal seat 32. The upperfront proximal seat 36 aligns with the lower front proximal seat 96. Also, the rear seats align similarly to the front seats. The distal seats are aligned at least substantially parallel to the proximal seats which are substantially parallel to the elongated slot 42 prior to closing. Because of the sliding hinge connection, the upper housing 12 can move linearly with respect to the lower housing 14, which allows for the usage of a hand tool or a screw fastener to close the connector. This allows for an easier connection that can be achieved using a hand tool, such as a pair of pliers, or an adequate amount of force can be achieved by screwing in the fastener 62.

As seen in FIG. 6, proper alignment of the cables A and E is also achieved because of the hoop-shaped appendage 40 and the boss 66 are spaced from one another a distance about equal to the width of the cable A, which is about the width of the proximal seats. Similarly, the boss 66 and the alignment arm 68 are spaced from one another a distance about equal to the width of the cable E, which is about the width of the distal seats. The boss 66 spans the distance between the distal seats and the proximal seats to provide lateral support to the cables in the connector. As seen in FIG. 6, this support is provided by the boss 66 even prior to closing of the connector. Likewise, the hoop-shaped appendage 40 and the alignment arm 68 provide lateral support to the cables prior to closing.

The height of the elongated slot 42, which forms a part of the sliding hinge 16, is about equal to the height of the cables, which is about equal to distance between the furthest points of corresponding upper and lower seats when the connector 10 is closed. This allows the seats to align with one another prior to closing of the connector 10. Also, the catches 56 are located near the bottom of the elongated slot 42 so that the upper housing 12 can rotate about the bottom of the slot which allows the proximal side of the lower housing 14 to be spaced from the proximal side of the upper housing 12, as seen in FIG. 6. The catches 56 limit the movement of the pin 44 along the elongated slot 42 which facilitates the parallel arrangement of the seats, as seen in FIG. 5. Once the upper seats are aligned with the lower seats, a force is applied on either the upper housing 12, the lower housing 14 or both so that the housings move substantially linearly with respect to one another. The substantially linear force results in the pin 44 being forced through the elongated slot 42 and through the catches 56 as the connector 10 is closed.

The splice connector has been described with reference to preferred embodiments. Obviously, modifications and alterations will occur to others upon reading and understanding the preceding detailed description. It is intended that the invention be construed as including all such modifications and alterations in so far as they come within the scope of the appended claims or the equivalents thereof.

1. A splice connector comprising:
a clam-shell housing including a first portion attached to a second portion via a sliding hinge, the housing defining a first cable seat and a second cable seat, each seat for receiving an associated cable to be spliced to another associated cable in the other seat;
a first insulation displacement connection (IDC) terminal received in the housing, wherein the first IDC terminal includes a first prong aligned with the first cable seat and a second prong aligned with the second cable seat, whereby the first IDC terminal electrically connects a wire of the first associated cable to a wire of the second associated cable.

2. The splice connector of claim 1, further comprising a notch formed in the first portion of the housing opposite the hinge and adjacent one of the cable seats, and an alignment member disposed on the second portion, wherein the notch receives the alignment member when the clamshell housing closes.

3. The splice connector of claim 1, wherein the sliding hinge includes a catch adapted to limit the movement in one direction of the first portion in relation to the second portion.

4. The splice connector of claim 1, wherein the sliding hinge is adapted such that the first portion is selectively removable from the second portion.

5. The splice connector of claim 1, further comprising a second IDC terminal spaced from the first IDC terminal in a first direction, wherein the second IDC terminal includes a first prong aligned with the first cable seat and a second prong aligned with the second cable seat.

6. The splice connector of claim 5, further comprising a third IDC terminal spaced from the first IDC terminal in a second direction, which is generally perpendicular to the first direction, and a fourth IDC terminal spaced from the first IDC terminal in a second direction and the third IDC terminal in a direction generally parallel to the first direction.

7. The splice connector of claim 1, further comprising a boss extending from the first portion spanning between the first cable seat and the second cable seat.

8. A splice connector comprising:
a first housing defining first and second cable receptacles spaced from one another in a first direction;
a second housing attached to the first housing; and
first and second terminals spaced from one another in a second direction generally parallel to the first direction and received in the first housing, wherein each terminal includes a first prong aligned with the first cable receptacle and a second prong aligned with the second cable receptacle.

9. The splice connector of claim 8, wherein the first housing includes a resilient clip and the second housing includes a catch that cooperates with the resilient clip to selectively attach the first housing to the second housing.

10. The splice connector of claim 8, wherein the first housing includes a first opening interposed between the first and second cable receptacles and the second housing includes a second opening that aligns with the first opening to receive a fastener to selectively attach the first housing to the second housing.

11. The splice connector of claim 8, further comprising third and fourth terminals received in the second housing and spaced from one another in a direction generally parallel to the second direction.

12. The splice connector of claim 8, wherein the first housing includes a hoop-shaped appendage defining an elongated slot and the second housing includes a pin received in the slot.

13. The splice connector of claim 12, wherein the first housing includes catches formed on an inner surface of the slot.

14. The splice connector of claim 12, wherein the hoop-shaped appendage is discontinuous forming a side opening in therein, wherein the side opening has a diameter approximately equal to the diameter of the pin.

15. The splice connector of claim 8, further comprising a boss extending from one of the first housing and the second housing interposed between the cable receptacles.

16. A method for splicing two electrical cables, wherein each cable includes at least two conductive wires and insulation material around each wire, with a splice connector having a clam-shell housing, the method comprising:
positioning first and second cables in respective first and second seats in a first housing portion of the clam-shell housing;
rotating a second housing portion of the clam-shell housing, which is attached to the first housing portion, in relation to the first housing portion;
at least substantially linearly moving at least one of the first housing portion and the second housing portion in relation to the other housing portion; and
piercing the insulation material of the first and second cable with an IDC terminal received in one of the housings to contact a first of the at least two wires in each cable.

17. The method of claim 16, further comprising piercing the insulation material of the first and second cable with another IDC terminal received in the other of the housings to contact a second of the at least two wires in each cable.

18. The method of claim 17, further comprising piercing the insulation material of the first and second cable with another IDC terminal received in one of the housings to contact the first of the at least two wires in each cable.

19. An LED light engine comprising:
a first electrical cable having at least two wire conductors;
at least one LED mounted to the first cable and electrically connected to the at least two conductors in the first cable;
a second electrical cable having at least two wire conductors;
at least one LED mounted to the second cable and electrically connected to the at least two conductors in the second cable; and
a splice connector comprising a clam-shell housing having a sliding hinge, wherein the clam-shell housing receives the first electrical cable and the second electrical.

20. A channel letter housing receiving the LED light engine of claim 19.
